(19) United States
(12) Patent Application Publication
(10) Pub. No.: US 2025/0260886 A1
(43) Pub. Date: Aug. 14, 2025

(54) ELECTRONIC DEVICE

(71) Applicant: CANON KABUSHIKI KAISHA, Tokyo (JP)

(72) Inventor: TAKAYUKI TAGUCHI, Kanagawa (JP)

(21) Appl. No.: 19/036,747

(22) Filed: Jan. 24, 2025

(30) Foreign Application Priority Data
Feb. 9, 2024 (JP) 2024-018735

(51) Int. Cl. H04N 23/54; G03B 17/14; G03B 17/56; H04N 23/52; H04N 23/68

(52) U.S. Cl. CPC H04N 23/54; G03B 17/14; G03B 17/561; H04N 23/52; H04N 23/6812; H04N 23/682

(57) ABSTRACT

An electronic device includes an electronic unit including a fixed portion and a movable portion movable with respect to the fixed portion, a first conductive part having a first main surface and a second main surface provided on a side opposite to the first main surface, and a second conductive part having a third main surface and a fourth main surface provided on a side opposite to the third main surface. The first main surface is positioned between the fixed portion and the second main surface. The third main surface is positioned between the movable portion and the fourth main surface. The third main surface is positioned between the fourth main surface and a virtual plane extending along the first main surface. Part of the movable portion is capable of moving with respect to the first conductive part and the second conductive part and intersecting with the virtual plane.

### BACKGROUND

### Field of the Technology

The present disclosure relates to an electronic device.

### Description of the Related Art

An electronic device including an electronic unit includes a conductive plate for the purpose of noise reduction and the like. International Publication WO 2011/129118 discloses an image pickup apparatus serving as an example of an electronic device. The image pickup apparatus disclosed in International Publication WO 2011/129118 includes a conductive shield member.

In addition, the electronic unit includes a fixed portion, a movable portion movable with respect to the fixed portion, and moves closer to and away from the conductive plate by movement of the movable portion. International Publication WO 2020/121541 discloses an image pickup apparatus serving as an example of an electronic device. The image pickup apparatus disclosed in International Publication WO 2020/121541 is configured to control image stabilization. The control of the image stabilization is performed by moving the movable portion including an image sensor such that shake of an optical image formed on the image sensor is reduced.

In recent years, miniaturization of electronic devices has been promoted. To advance miniaturization of electronic devices, an electronic unit needs to be accommodated in a small space inside an exterior of an electronic device. Further, a movable space for the movable portion of the electronic unit needs to be secured. In addition, for the electronic unit, a measure against a noise caused by electrostatic discharge (ESD) or the like is also needed.

### SUMMARY

According to a first aspect of the present disclosure, an electronic device includes an electronic unit including a fixed portion and a movable portion movable with respect to the fixed portion, a first conductive part having a first main surface and a second main surface provided on a side opposite to the first main surface, and a second conductive part having a third main surface and a fourth main surface provided on a side opposite to the third main surface. The first main surface is positioned between the fixed portion and the second main surface. The third main surface is positioned between the movable portion and the fourth main surface. The third main surface is positioned between the fourth main surface and a virtual plane including the first main surface and extending along the first main surface. Part of the movable portion is capable of moving with respect to the first conductive part and the second conductive part and intersecting with the virtual plane.

According to a second aspect of the present disclosure, an electronic device includes an electronic unit including a fixed portion and a movable portion movable with respect to the fixed portion, a first conductive part having a first main surface and a second main surface provided on a side opposite to the first main surface, and a second conductive part having a third main surface and a fourth main surface provided on a side opposite to the third main surface. A virtual plane including the first main surface and extending along the first main surface has a first region overlapping with the first conductive part in a direction orthogonal to the virtual plane, a second region overlapping with the second conductive part in the direction orthogonal to the virtual plane, and a third region between the first region and the second region. A current is configured to flow from the first conductive part to the second conductive part. Part of the movable portion is capable of moving with respect to the first conductive part and the second conductive part and intersecting with the third region.

Further features of the present disclosure will become apparent from the following description of exemplary embodiments with reference to the attached drawings.

### BRIEF DESCRIPTION OF THE DRAWINGS

FIG. 1 is a schematic perspective view of a camera that is an image pickup apparatus serving as an example of an electronic device according to a first embodiment.

FIG. 2A is a schematic section view of the camera according to the first embodiment.

FIG. 2B is an explanatory diagram of an image pickup module, a processing module, and a flexible printed circuit according to the first embodiment.

FIG. 3 is a perspective view of a configuration of part of the camera according to the first embodiment.

FIG. 4 is a bottom view of the camera according to the first embodiment.

FIG. 5 is a perspective view of an electronic unit according to the first embodiment.

FIG. 6 is an exploded perspective view of the electronic unit according to the first embodiment.

FIG. 7A is a section view of part of the camera according to the first embodiment.

FIG. 7B is a section view of the camera according to the first embodiment.

FIG. 8A is an explanatory diagram of a camera of a comparative example.

FIG. 8B is an explanatory diagram of the camera according to the first embodiment.

FIG. 9 is an explanatory diagram of a camera according to a first modification example.

FIG. 10A is a graph illustrating a result of simulation.

FIG. 10B is a graph illustrating a result of simulation.

FIG. 11A is an explanatory diagram of a camera according to a second embodiment.

FIG. 11B is an explanatory diagram of the camera according to the second embodiment.

FIG. 12A is an explanatory diagram of a camera according to a second modification example.

FIG. 12B is an explanatory diagram of the camera according to the second modification example.

FIG. 13A is an explanatory diagram of a camera according to a third embodiment.

FIG. 13B is an explanatory diagram of the camera according to the third embodiment.

FIG. 14A is an explanatory diagram of a camera according to a third modification example.

FIG. 14B is an explanatory diagram of a camera according to a fourth modification example.

### DESCRIPTION OF THE EMBODIMENTS

Exemplary embodiments of the present disclosure will be described in detail below with reference to drawings. To be noted, in each drawing, the same members will be denoted by the same reference signs, and redundant description will be omitted. In the embodiments below, directions will be expressed in an XYZ coordinate system that is an orthogonal coordinate system. An X axis, a Y axis, and a Z axis are orthogonal to each other. In addition, the direction of the X axis, the direction of the Y axis, and the direction of the Z axis will be also respectively referred to as an X direction, a Y direction, and a Z direction. The Y direction is, for example, a direction along an optical axis (optical axis direction). In addition, a plane including the X axis and the Y axis will be referred to as an X-Y plane.

### First Embodiment

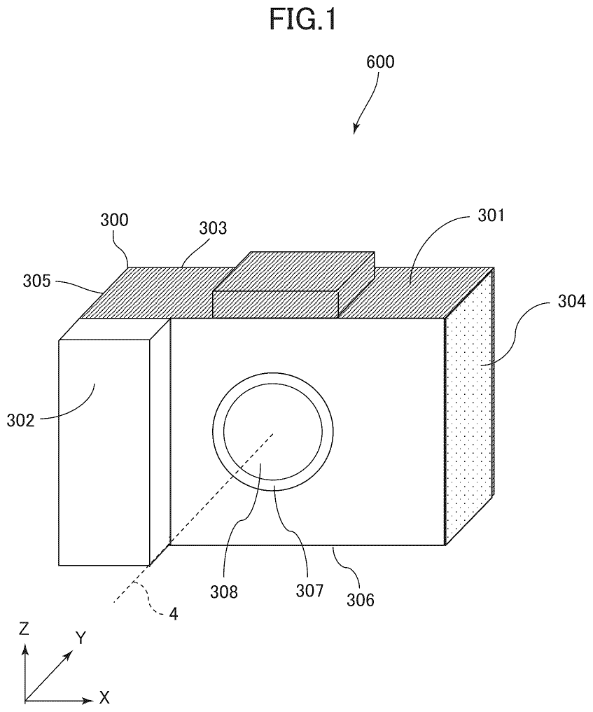

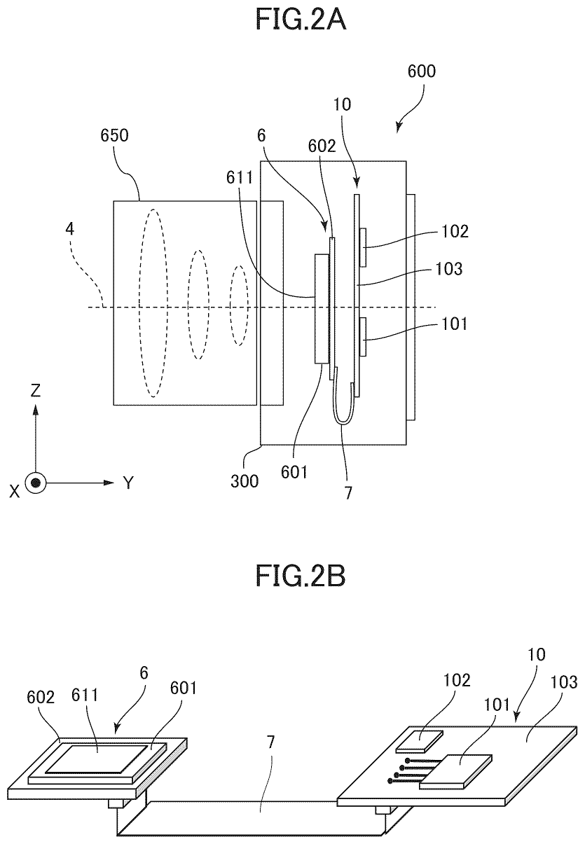

FIG. 1 is a schematic perspective view of a camera 600 that is an image pickup apparatus serving as an example of an electronic device according to a first embodiment. FIG. 2A is a schematic section view of the camera 600 according to the first embodiment.

The camera 600 is a digital camera of a lens replacing type, and a lens unit (lens barrel) 650 including a lens is attachable to and detachable from the camera (camera body) 600. The camera 600 includes an exterior 300, and an image pickup module 6 and a processing module 10 disposed inside the exterior 300. The image pickup module 6 and the processing module 10 are electrically interconnected by a flexible printed circuit 7. An unillustrated battery is provided inside the exterior 300. The flexible printed circuit 7 includes a flexible wiring member.

FIG. 2B is an explanatory diagram of the image pickup module 6, the processing module 10, and the flexible printed circuit 7 according to the first embodiment. FIG. 2B schematically illustrates the image pickup module 6, the processing module 10, and the flexible printed circuit 7 in the state of being out of the exterior 300 and laid out.

The image pickup module 6 includes an image sensor 601 that performs photoelectric conversion, an unillustrated communication circuit required for mutual communication with the processing module 10, and a wiring board 602. The image sensor 601 and the unillustrated communication circuit are mounted on the wiring board 602. The wiring board 602 can be a rigid printed wiring board. The wiring board 602 is provided with an unillustrated circuit, unillustrated wiring, and an unillustrated part that are required for the operation of the image sensor 601. The image sensor 601 is, for example, a complementary metal oxide semiconductor (CMOS) image sensor or a charge coupled device (CCD) image sensor. The image sensor 601 has a light receiving surface 611. An optical path is secured on the light receiving surface 611 side of the image sensor 601 such that light is incident on the light receiving surface 611 of the image sensor 601 in a direction of an optical axis 4. The incident direction of the light along the optical axis 4 is the +Y direction. The Y axis is an axis orthogonal to the light receiving surface 611. The image sensor 601 converts an optical image (object light) focused on the light receiving surface 611 by the lens unit 650 into an electric signal (image signal). The electric signal is output to the processing module 10.

The image sensor 601 can be formed in a package form as a semiconductor package. The image sensor 601 includes a semiconductor integrated circuit including a plurality of photoelectric conversion elements, and a ceramic substrate (interposer) on which the semiconductor integrated circuit is mounted. To be noted, in the image sensor 601, the interposer may be omitted, and the semiconductor integrated circuit may be directly mounted on the wiring board 602. Further, in the image pickup module 6, the wiring board 602 may be omitted, and the flexible printed circuit 7 may be directly connected to the image sensor 601.

The processing module 10 includes an image processing engine 101, a power source circuit 102, an unillustrated communication circuit required for mutual communication with the image pickup module 6, and a wiring board 103. The image processing engine 101, the power source circuit 102, and the unillustrated communication circuit are mounted on the wiring board 103. The wiring board 103 may be a rigid printed wiring board. The image processing engine 101 is, for example, a digital signal processor, and is an image processing device having a function of obtaining an electric signal from the image sensor 601 via the flexible printed circuit 7, performing processing of correcting the obtained electric signal, and generating image data. The image processing engine 101 receives input of an image signal from the image sensor 601 through a transmission path. The flexible printed circuit 7 serves as the transmission path in the first embodiment. The power source circuit 102 is connected to an unillustrated battery, and supplies power to the image processing engine 101, the image pickup module 6, and the like by applying a predetermined voltage to the image processing engine 101, the image pickup module 6, and the like.

The transmission of the image signal from the image pickup module 6 to the processing module 10 is performed via the flexible printed circuit 7. One end of the flexible printed circuit 7 is connected to, for example, a mounting surface of the wiring board 602 on the opposite side to the mounting surface of the wiring board 602 on which the image sensor 601 is mounted. The other end of the flexible printed circuit 7 is connected to, for example, a mounting surface of the wiring board 103 on the opposite side to the mounting surface of the wiring board 103 on which the image processing engine 101 is mounted. The image pickup module 6 and the flexible printed circuit 7 are connected to each other via a connector, and the processing module 10 and the flexible printed circuit 7 are connected to each other via a connector. To be noted, a power source current, a control signal, and the like are also communicated between the image pickup module 6 and the processing module 10 via the flexible printed circuit 7 in addition to the image signal. That is, the flexible printed circuit 7 includes a differential signal line used for transmission of an image signal, a power supply line used for power supply, a ground line serving as a reference potential, and the like. The image signal transmitted from the image pickup module 6 to the processing module 10 via the flexible printed circuit 7 can be a digital signal, but may be an analog signal.

The exterior 300 illustrated in FIG. 1 includes a top exterior 301 positioned in an upper portion the camera 600, a front exterior 302 positioned in a front portion (light incident side) of the camera 600, a back exterior 303 positioned in a rear portion on the opposite side to the front exterior 302, a right side surface exterior 304 positioned on the right side of the camera 600 in front view of the front exterior 302, a left side surface exterior 305 positioned on the left side of the camera 600 in front view of the front exterior 302, and a bottom exterior 306 positioned in a lower portion of the camera 600.

The top exterior 301 is an exterior member formed from, for example, conductive resin. The front exterior 302 is an exterior member formed from, for example, metal such as a magnesium alloy. The front exterior 302 includes an annular mount portion 307 to which the lens unit 650 of FIG. 2A is attached. A through hole 308 serving as a passage for object light irradiating the light receiving surface 611 of the image sensor 601 via the lens unit 650 is defined on the inner side of the mount portion 307. The back exterior 303 is an exterior member positioned on the rear side of the exterior 300. The back exterior 303 is formed from, for example, the same conductive resin as the top exterior 301. The right side surface exterior 304 is an exterior member formed from, for example, an insulating resin, and provided with an unillustrated external interface connecting connector. In addition, the left side surface exterior 305 is connected to unillustrated bent portions respectively provided in the front exterior 302 and the back exterior 303. The bottom exterior 306 is constituted by a plastic exterior member, for example, formed from an insulating resin, and has an insertion hole for an unillustrated battery required for driving the camera 600. That is, the bottom exterior 306 is preferably not conductive to secure insulation from the battery. The exteriors 301 to 306 are mutually connected via unillustrated metal (conductive) screws.

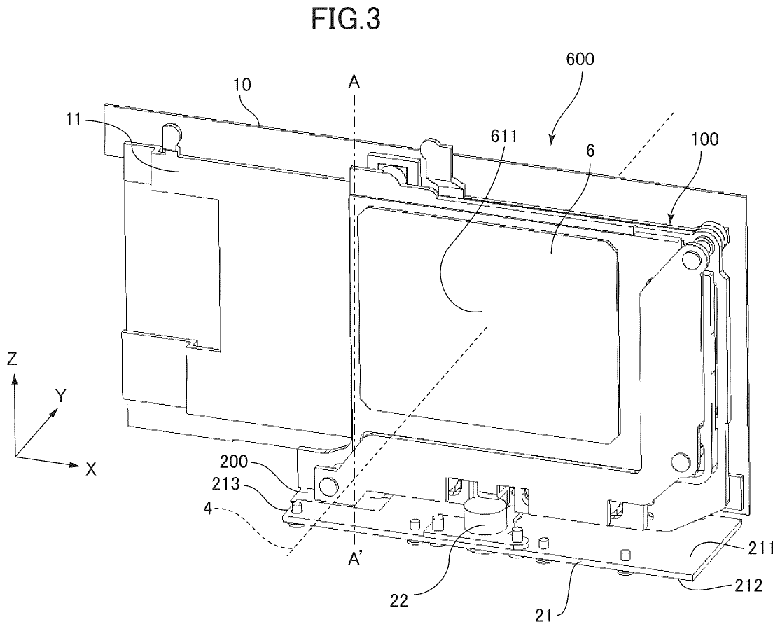

FIG. 3 is a perspective view of part of elements of the camera 600 according to the first embodiment. The camera 600 includes an electronic unit 100, a plate 11 disposed between the electronic unit 100 and the processing module 10 in the Y direction, and a bottom plate 21 disposed on the −Z side with respect to the electronic unit 100. The electronic unit 100 includes the image pickup module 6 described above.

The plate 11 and the bottom plate 21 are fixed to the exterior 300 of FIG. 1 by using unillustrated screws or the like. The electronic unit 100 is fixed to the exterior 300 of FIG. 1 or the plate 11 by using unillustrated screws or the like. Here, “A” being fixed to “B” means the same thing as “B” being fixed to “A”. In addition, examples of viewing in the Z direction include seeing through something in the Z direction. The same applies to the X direction and the Y direction.

The plate 11 is a conductive plate having approximately the same area as the processing module 10 as viewed in the Y direction. The processing module 10 is fixed to the plate 11 by using conductive screws or the like at a plurality of positions, and is thus electrically connected to the plate 11. As described above, since the processing module 10 is electrically connected to the plate 11 at a plurality of positions, the plate 11 functions as a heat dissipation member that dissipates heat from the processing module 10 to the outside, and as a ground serving as a reference of the potential. To be noted, the plate 11 may be configured to be electrically connected to the exterior 300.

The bottom plate 21 is a conductive plate, and is an example of a first conductive part. The bottom plate 21 is positioned at a lower portion of the camera 600. As viewed in the Z direction, the bottom plate 21 is a conductive member of an approximate rectangular shape, and is fixed to the bottom exterior 306 of the exterior 300 illustrated in FIG. 1 by using conductive screws or the like. The bottom plate 21 has a main surface 211 and a main surface 212 on the opposite side to the main surface 211. The main surface 211 is a main surface facing toward the electronic unit 100, that is, a main surface facing inward, and the main surface 212 is a main surface facing toward the bottom exterior 306, that is, a main surface facing outward. That is, the bottom plate 21 is disposed between the bottom exterior 306 and the electronic unit 100. The main surface 211 is an example of a first main surface, and the main surface 212 is an example of a second main surface. The main surfaces 211 and 212 are, for example, flat surfaces parallel to the X-Y plane. The main surfaces 211 and 212 are substantially parallel to each other. Therefore, a direction orthogonal to the main surface 211 is substantially the same as a direction orthogonal to the main surface 212.

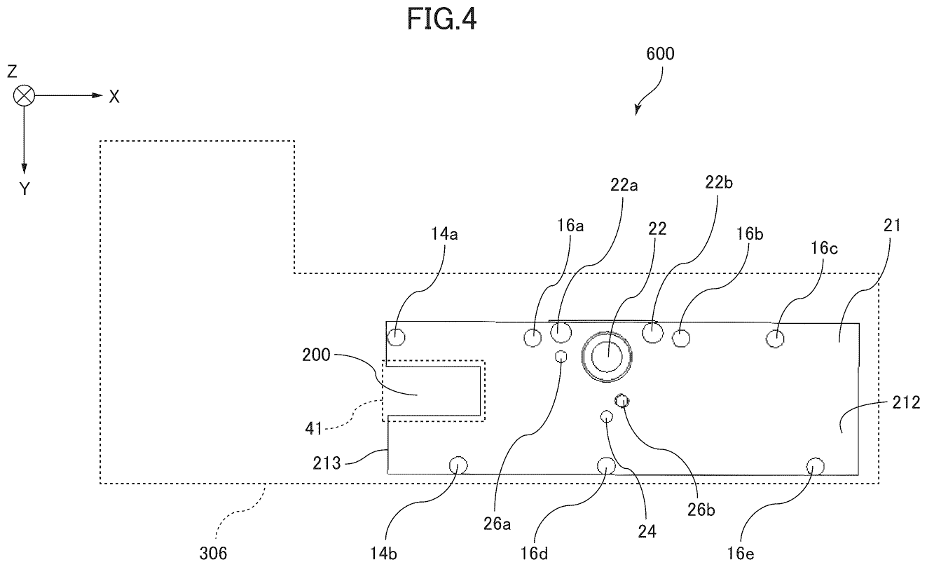

FIG. 4 is a bottom view of the camera 600 according to the first embodiment. To be noted, in FIG. 4, the bottom exterior 306 is indicated by a broken line for the sake of convenience of description. A screw receiving portion 22 that receives a screw of a tripod is fixed to the bottom plate 21. For example, a cylindrical portion of the screw receiving portion 22 is inserted in an unillustrated hole provided at an approximate center portion of the bottom plate 21, and is fixed to the bottom plate 21 by using screws 22a, 22b, and 24. The screws 22a, 22b, and 24 can be formed from metal, that is, can be conductive screws. The screw receiving portion 22 includes a plurality of protrusion portions 26a and 26b for positioning. The plurality of protrusion portions 26a and 26b are fit in a plurality of holes provided in the bottom plate 21, and thus the screw receiving portion 22 is positioned to the bottom plate 21.

The screw receiving portion 22 is formed from metal, that is, is a conductive member. The cylindrical portion of the screw receiving portion 22 has a screw hole for receiving the screw of an unillustrated camera tripod. The camera tripod is screwed to and thus fixed to the screw receiving portion 22, and thus the camera 600 as a whole including the bottom plate 21 and the electronic unit 100 can be fixed to the camera tripod.

To be noted, since the camera tripod is coupled to the screw receiving portion 22, the screw hole of the screw receiving portion 22 is not covered by the bottom exterior 306. However, part other than the screw hole may be covered by the bottom exterior 306. Therefore, the bottom plate 21 and part of the screw receiving portion 22 are covered by the bottom exterior 306.

The bottom exterior 306 and the bottom plate 21 are fixed to the front exterior 302 by using screws 14a, 16a, 16b, and 16c. The screws 14a, 16a, 16b, and 16c can be formed from metal, that is, can be conductive members. In addition, the bottom exterior 306 and the bottom plate 21 are fixed to the back exterior 303 by using screws 14b, 16d, and 16e. The screws 14b, 16d, and 16e can be formed from metal, that is, can be conductive members.

The bottom plate 21 has an effect of shielding a noise from the outside or the inside of the camera 600. Further, in the case where the bottom plate 21 is supported by the tripod via the screw receiving portion 22, since a force from the weight of the camera 600 can be act on the bottom plate 21, the area and the thickness of the bottom plate 21 are set such that high strength can be achieved.

The electronic unit 100 includes a correction mechanism that moves the image pickup module 6 in a translational direction approximately orthogonal to the optical axis 4 and in a rotational direction about the optical axis 4, and thus suppresses a situation in which shake of the camera 600 caused by shake of the hand of the user affects the captured image.

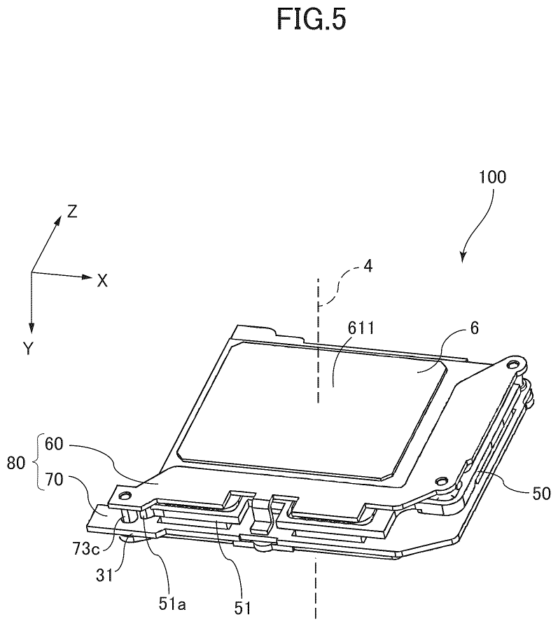

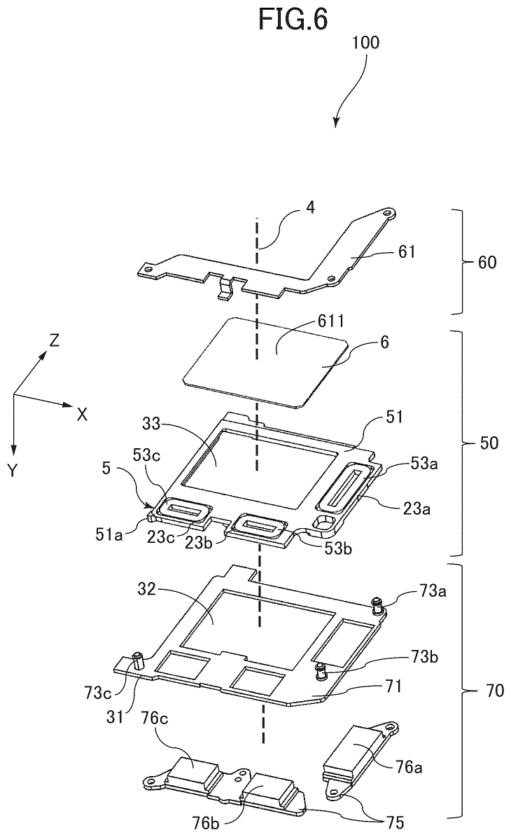

FIG. 5 is a perspective view of the electronic unit 100 according to the first embodiment. FIG. 6 is an exploded perspective view of the electronic unit 100 according to the first embodiment.

The electronic unit 100 includes a movable portion 50 including the image pickup module 6 described above, a fixed portion 80 fixed to the plate 11 or the exterior 300, and an actuator 5. The movable portion 50 is configured to be movable in a predetermined movable range with respect to the fixed portion 80. The fixed portion 80 is also a support portion that supports the movable portion 50.

The movable direction of the movable portion 50 includes a direction intersecting with the main surface 211, which is a direction in a plane parallel to the X-Z plane orthogonal to the main surface 211 in the first embodiment. That is, the movable direction of the movable portion 50 includes a translational direction parallel to the X-Z plane, and a rotational direction of rotating within the X-Z plane. As described above, the movable portion 50 is configured to be movable in a plane parallel to the X-Z plane within a predetermined movable range.

The actuator 5 is configured to move the movable portion 50 with respect to the fixed portion 80. The fixed portion 80 includes a fixed body 60 serving as a first fixed body, and a fixed body 70 serving as a second fixed body fixed to the fixed body 60. The movable portion 50 is disposed between the fixed body 60 and the fixed body 70 in the Y direction.

The movable portion 50 moves with respect to the processing module 10, and therefore the flexible printed circuit 7 is used as a transmission path for the image signal between the image sensor 601 and the image processing engine 101. The movable portion 50 includes the image pickup module 6, a movable frame 51, and an unillustrated flexible printed circuit board. The actuator 5 is disposed in the movable frame 51. The actuator 5 includes coils 53a, 53b, and 53c. The unillustrated flexible printed circuit board supplies power to the coils 53a, 53b, and 53c.

The fixed body 60 includes a first yoke 61. The fixed body 70 includes a base plate 71, spacers 73a, 73b, and 73c, a second yoke 75, and magnets 76a, 76b, and 76c that are permanent magnets. The base plate 71 is an example of a base member. An unillustrated rotary ball that movably supports the movable portion 50 is disposed between the fixed body 70 and the movable portion 50. One or both of the fixed body 60 and the fixed body 70 are fixed to the exterior 300 by using a screw or the like. The first yoke 61 and the second yoke 75 are each formed from a magnetic metal body. The first yoke 61, the second yoke 75, and the magnets 76a, 76b, and 76c constitute a magnetic circuit that is a closed magnetic path.

The magnets 76a, 76b, and 76c are fixed to the second yoke 75 by using an adhesive in a state of being attracted to the second yoke 75. The spacers 73a, 73b, and 73c are disposed between the first yoke 61 and the second yoke 75, and thus the distance between the first yoke 61 and the second yoke 75 is maintained at a predetermined value.

The movable portion 50 is disposed between the first yoke 61 and the second yoke 75. A gap is provided between the movable portion 50 and the first yoke 61 and between the movable portion 50 and the second yoke 75. The spacers 73a, 73b, and 73c are spacers defining the distance between the fixed bodies 60 and 70. The spacers 73a, 73b, and 73c are each also a stopper for the movable portion 50, and each include a cylindrical portion and rubber provided on a side surface of the cylindrical portion. That is, the spacers 73a, 73b, and 73c define the movable range of the movable portion 50.

The base plate 71 is formed from a conductive metal, and is preferably formed from, for example, nonmagnetic stainless steel. The thickness of each of the magnets 76a, 76b, and 76c is larger than the thickness of the base plate 71. The base plate 71 is provided with through holes in which the magnets 76a, 76b, and 76c are inserted. Further, the second yoke 75 is fixed to the base plate 71 by using an unillustrated screw, and thus the magnets 76a, 76b, and 76c protrude from the base plate 71. In addition, a through hole 32 having an approximate rectangular shape penetrating in the direction of the optical axis 4 is provided at a center portion of the base plate 71.

The image pickup module 6 and the unillustrated flexible printed circuit board are mounted on the movable frame 51. Further, the coils 53a, 53b, and 53c are mounted on a mounting surface of the unillustrated flexible printed circuit board on the fixed body 70 side.

A through hole 33 having an approximate rectangular shape penetrating in the direction of the optical axis 4 is provided at a center portion of the movable frame 51. In addition, through holes 23a, 23b, and 23c penetrating in the direction of the optical axis 4 are provided at an end portion of the movable frame 51. The coil 53a is disposed in the through hole 23a, the coil 53b is disposed in the through hole 23b, and the coil 53c is disposed in the through hole 23c. An insulating positioning member for positioning and fixing the coil 53a is disposed in the through hole 23a. An insulating positioning member for positioning and fixing the coil 53b is disposed in the through hole 23b. An insulating positioning member for positioning and fixing the coil 53c is disposed in the through hole 23c.

In addition, since the through hole 33 is provided in the movable frame 51, interference of mounted parts such as connector parts provided on the wiring board 602 of the image pickup module 6 with the movable frame 51 and the base plate 71 can be avoided. In addition, the flexible printed circuit 7 illustrated in FIG. 2B is disposed to extend through the through hole 33 of the movable frame 51 and the through hole 32 of the base plate 71, and electrically interconnects the image pickup module 6 and the processing module 10.

The unillustrated flexible printed circuit board of the movable portion 50 is connected to an unillustrated driving circuit. The unillustrated driving circuit generates a force following the Fleming's left hand rule in each of the coils 53a to 53c by supplying a current to each of the coils 53a to 53c via the unillustrated flexible printed circuit board. As a result of this, the coils 53a to 53c can move the movable portion 50.

In addition, an unillustrated magnetic sensor is disposed in the movable portion 50. The unillustrated driving circuit detects a movement position of the movable portion 50 in a direction of a plane orthogonal to the optical axis 4 by using an unillustrated magnetic sensor, performs feedback control on the basis of the detection result, and thus performs control described above to correct the shake. For example, a hole element or the like can be used as the magnetic sensor, and the movement position of the movable portion 50 is detected by using a magnetic circuit including the magnets 76a, 76b, and 76c.

To be noted, the electronic unit 100 may include a magnet and a magnetic circuit for position detection instead of the magnetic sensor. In addition, the number of the magnets is not limited to three. For example, the magnets 76a, 76b, and 76c may each include two magnet pieces. Further, the two magnet pieces may be fixed to the second yoke 75 at magnetic polarities opposite to each other. According to such a configuration, the driving force for driving the movable portion 50 is improved. In addition, the magnets 76a, 76b, and 76c each may include three or more magnet pieces. The three magnet pieces may be arranged such that the direction of the magnetic poles are optimized, for example, such that the magnetic field intensity in a specific direction is maximized.

The image pickup operation by the image pickup module 6 and the shake correction operation by the actuator 5 are performed by known image pickup means, image processing means, record reproducing means, control means, and the like.

Accompanied by miniaturization of the camera 600, the electronic unit 100 is accommodated in a small space inside the exterior 300. To suppress interference between the movable portion 50 and the bottom plate 21 while securing a movable range of the movable portion 50 of the electronic unit 100, the bottom plate 21 has a cutout 200 that part of the movable portion 50 can enter as illustrated in FIGS. 3 and 4. The cutout 200 is a space defined by the bottom plate 21. The shape of the cutout 200 is rectangular as viewed in the Z direction, but the shape thereof is not limited to this. For example, the cutout 200 may have a V shape or a U shape as viewed in the Z direction, and may be in any shape as long as the interference with the electronic unit 100 can be suppressed.

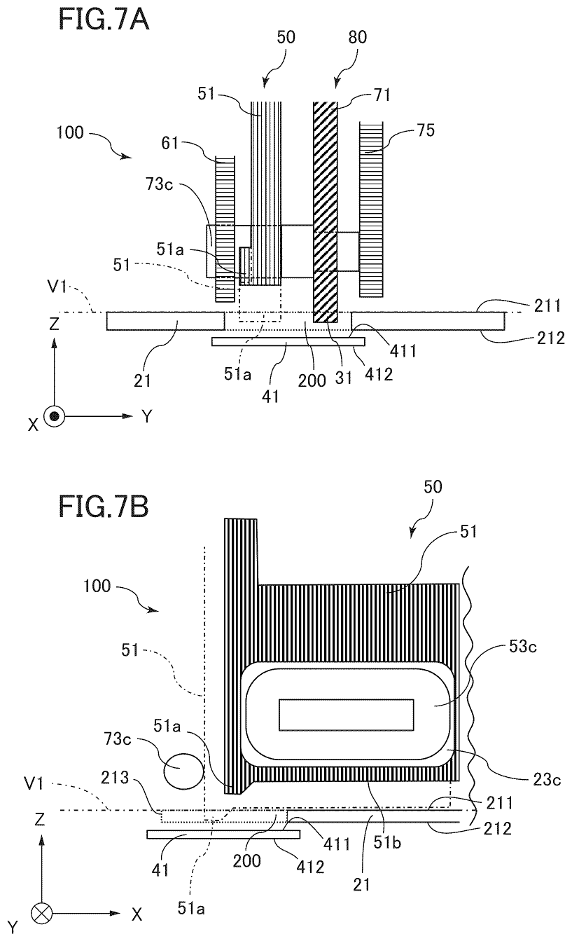

FIGS. 7A and 7B are each a section view of part of the camera 600 according to the first embodiment. FIG. 7A schematically illustrates a cross-section of part of the camera 600 along a plane that is parallel to the Y-Z plane and that includes a line A-A′ of FIG. 3 as viewed in the −X direction. Specifically, FIG. 7A schematically illustrates a cross-section of the bottom plate 21 and members near the bottom plate 21.

In addition, FIG. 7B schematically illustrates a cross-section of part of the camera 600 along a plane that is parallel to the X-Z plane and that includes a center of the cutout 200 in the Y direction as viewed in the +Y direction. Specifically, FIG. 7B schematically illustrates a cross-section of the bottom plate 21 and members near the bottom plate 21.

In the bottom plate 21, the cutout 200 is formed at a position where part of the movable portion 50 can enter. Part of the movable portion 50 is a conductive portion. In the first embodiment, the part of the movable portion 50 that can enter the cutout 200 is a protrusion portion 51a of the movable frame 51. In the description below, the protrusion portion 51a will be also referred to as a part 51a. The cutout 200 is a cutout provided at an end portion of the bottom plate 21 in the X direction. The X direction is also a longitudinal direction of the bottom plate 21. That is, the cutout 200 is formed to be recessed in the +X direction with respect to an end surface 213 of the bottom plate 21 that is on the distal end side in the −X direction. The protrusion portion 51a of the movable frame 51 enters the cutout 200 and retracts from the cutout 200 in accordance with the position and orientation of the movable frame 51. That is, the movable portion 50 is movable in a space defined by the cutout 200 provided in the bottom plate 21.

The movable frame 51 includes an end surface 51b that opposes the main surface 211 of the bottom plate 21 in the Z direction. The Z direction is a direction orthogonal to the main surfaces 211 and 212. The protrusion portion 51a protrudes in the −Z direction (that is, toward the main surface 211) with respect to the end surface 51b. To be noted, although no other member is disposed between the main surface 211 and the end surface 51b, another member may be disposed therebetween as long as the movement of the movable portion 50 is not interrupted.

In FIGS. 7A and 7B, the movable frame 51 having moved to a limit position in the −Z direction and a limit position in the −X direction in the movable range of the movable frame 51 is indicated by a one-dot chain line. That is, the movable frame 51 in a state in which the protrusion portion 51a of the movable frame 51 has entered the cutout 200 is indicated by a one-dot chain line. As illustrated in FIG. 7B, in the case where the movable frame 51 has moved to the limit position in the −Z direction and the limit position in the −X direction, the movable frame 51 abuts the spacer 73c, and thus the movement thereof in the −X direction is restricted. In addition, although the illustration thereof is omitted, the movable frame 51 includes the protrusion portion 51a protruding in the −Z direction such that the movement of the movable frame 51 in the −X direction is restricted, that is, the movable frame 51 can abut the spacer 73c, even in a state in which the movable frame 51 has moved to a limit position in the +Z direction.

To be noted, the protrusion portion 51a of the movable portion 50 can be retracted from the cutout 200 depending on the position and orientation of the movable portion 50 in the movable range. In FIGS. 7A and 7B, the movable frame 51 in a state in which the protrusion portion 51a has retracted from the cutout 200 is indicated by a solid line.

Since the bottom plate 21 has the cutout 200 that part of the movable portion 50 can enter, the distance between the bottom plate 21 and the electronic unit 100 can be reduced, and thus the camera 600 can be miniaturized.

In addition, as illustrated in FIG. 7A, part of the fixed portion 80 has entered the cutout 200. That is, part of the fixed portion 80 is positioned at the cutout 200. Part of the fixed portion 80 is a conductive portion. In the first embodiment, part of the fixed portion 80 is a part 31 of the base plate 71 of the fixed body 70 of the fixed portion 80. The part 31 of the fixed portion 80 has entered the cutout 200. That is, the part 31 of the fixed portion 80 is positioned in the cutout 200. To be noted, although the part 31 of the base plate 71 has entered the cutout 200 as part of the fixed portion 80, the configuration is not limited to this. For example, part of the fixed portion that enters the cutout 200 may be part of the fixed body 60, or part of a member of the fixed body 70 other than the base plate 71. As described above, since the fixed portion 80 is disposed inside the exterior 300 such that part of the fixed portion 80 is positioned in the cutout 200, the distance between the bottom plate 21 and the electronic unit 100 can be reduced, and the camera 600 can be miniaturized.

Incidentally, an externally originated noise caused by electrostatic discharge (ESD) or the like may be applied to the bottom plate 21. In the description below, a noise related to ESD will be referred to as an ESD noise. In the first embodiment, the electronic unit 100 includes a shield member 41 disposed at a position opposing the cutout 200.

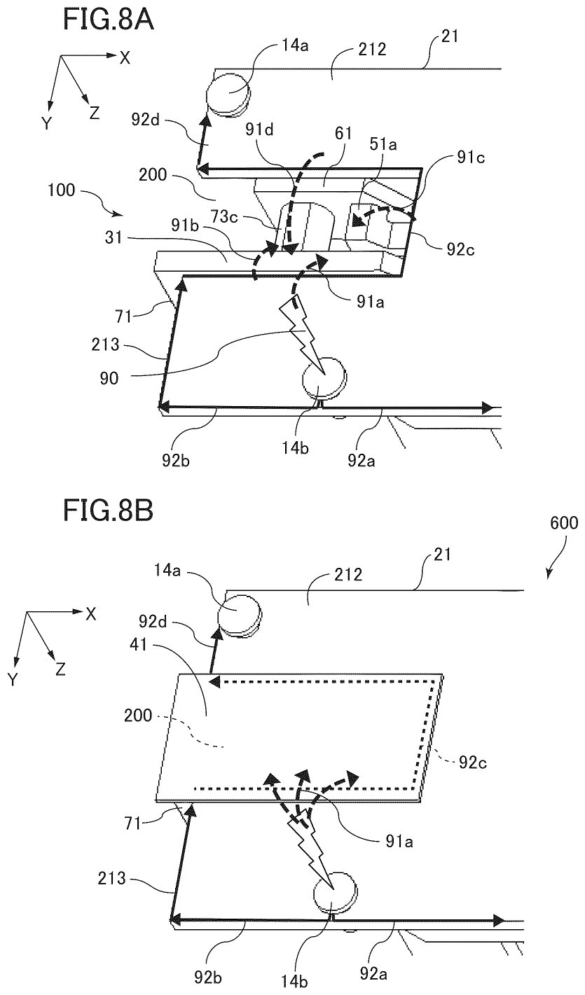

Here, a camera of a comparative example not including a shield member will be described. FIG. 8A is an explanatory diagram of a camera of a comparative example. FIG. 8A schematically illustrates part of an inner structure of the camera of the comparative example in which illustration of the bottom exterior 306 of the camera of the comparative example is omitted. Further, FIG. 8A illustrates a perspective view of the inner structure of the camera as viewed in the +Z direction from below the camera of the comparative example.

The screw 14a is used for fixing the bottom exterior 306 and the bottom plate 21 to the front exterior 302, and the screw 14b is used for fixing the bottom exterior 306 and the bottom plate 21 to the back exterior 303. Since high rigidity is required for the screws 14a and 14b, the screws 14a and 14b are formed from metal. When the ESD noise is applied to the screw 14b, a current related to ESD flows along an edge of the bottom plate 21. In the description below, a current related to ESD will be referred to as an ESD current.

Reference signs 92a, 92b, 92c, and 92d denote main ESD currents among ESD currents flowing in the bottom plate 21. In FIG. 8A, the directions in which the ESD currents 92a, 92b, 92c, and 92d flow are indicated by arrows. Reference signs 91a, 91b, 91c, and 91d denote main electromagnetic field noises among electromagnetic field noises that are spatially propagated. In FIG. 8A, the directions in which the electromagnetic field noises 91a, 91b, 91c, and 91d are propagated are indicated by arrows. High electric charges are stored in an ESD application source 90, and the charges are discharged all at once to the screw 14b when the ESD application source 90 comes into contact with the screw 14b. Therefore, a large electromagnetic field noise 91a is generated from the ESD application source 90. The ESD application source 90 can be, for example, a user. The electromagnetic field noise 91a is propagated from the ESD application source 90 to the electronic unit 100 via the cutout 200.

The ESD applied from the ESD application source 90 is propagated in the bottom plate 21 via the screw 14b. Since the ESD current has a high frequency characteristic, the ESD current has a characteristic of flowing more in the edge of a metal body to which the ESD current is applied. Therefore, the ESD applied to the screw 14b flows along the edge of the bottom plate 21 as the ESD currents 92a, 92b, 92c, and 92d.

The bottom plate 21 has the cutout 200. Therefore, the ESD current 92c flows along the edge defining the cutout 200 in the bottom plate 21. Then, the ESD current 92d having reached the screw 14a flows to the exterior 300.

When the ESD current flows in the bottom plate 21, an electromagnetic field noise is generated from the current path of the ESD current. Therefore, as a result of the ESD current 92c flowing along the edge defining the cutout 200, the electromagnetic field noises 91b, 91c, and 91d are generated from the edge defining the cutout 200. The electromagnetic field noises 91b, 91c, and 91d are propagated to the electronic unit 100 via the cutout 200.

As illustrated in FIG. 8A, in the case where part of the electronic unit 100 has entered the cutout 200, most of the electromagnetic field noises 91a to 91d reach the part of the electronic unit 100. As a result of the electromagnetic field noises 91a to 91d reaching the electronic unit 100, an ESD noise enters the electronic unit 100. The ESD noise having entered the electronic unit 100 reaches the image pickup module 6, or reaches the processing module 10 via the flexible printed circuit 7 and the plate 11. The ESD noise having entered the electronic unit 100 in this manner can lead to occurrence of disturbance of a captured image (image data) and occurrence of stoppage caused by an error. Particularly, in the case where the part 51a of the movable portion 50 is positioned in the cutout 200, the electronic unit 100 is more likely to be affected by the electromagnetic field noises 91a to 91d.

To address this, as illustrated in FIGS. 7A and 7B, the electronic unit 100 of the first embodiment includes the shield member 41 that is conductive. The shield member 41 is an example of a second conductive part. At least part of the shield member 41 is positioned on the main surface 212 side with respect to the bottom plate 21 in the Z direction. That is, at least part of the shield member 41 is positioned between the bottom plate 21 and the bottom exterior 306 in the Z direction. To be noted, in the case where part of the shield member 41 is positioned between the bottom plate 21 and the bottom exterior 306 in the Z direction, the part of the shield member 41 serves as a second conductive part, and the shield member 41 as a whole serves as a second conductive member including the second conductive part. In the first embodiment, the entirety of the shield member 41 is positioned on the main surface 212 side in the Z direction with respect to the bottom plate 21. That is, the entirety of the shield member 41 is positioned between the bottom plate 21 and the bottom exterior 306 in the Z direction. Therefore, in the first embodiment, the shield member 41 serves as a second conductive part and also a second conductive member. In addition, although the bottom plate 21 as a whole serves as a first conductive part and also a first conductive member in the first embodiment, part of the bottom plate 21 may serve as a first conductive part and the bottom plate 21 as a whole may serve as a first conductive member including the first conductive part.

The shield member 41 is a conductive member having a plate shape. The shield member 41 has a main surface 411 and a main surface 412 on the opposite side to the main surface 411. The main surface 411 is an example of a third main surface, and the main surface 412 is an example of a fourth main surface. The shield member 41 may be, for example, a metal member formed from aluminum, stainless steel, or the like, or may be formed from a conductive resin imparted with conductivity obtained by mixing a conductive material in a resin material.

As illustrated in FIGS. 7A and 7B, a virtual plane V1 including the main surface 211 and extending along the main surface 211 is defined. The main surface 411 is positioned between the virtual plane V1 and the main surface 412. In addition, the main surface 211 is positioned between the fixed portion 80 and the main surface 212. In addition, the main surface 411 is positioned between the movable portion 50 and the main surface 412. Further, part of the movable portion 50 is capable of moving with respect to the bottom plate 21 and the shield member 41 and intersecting with the virtual plane V1. As a result of this configuration, according to the first embodiment, a technique advantageous for miniaturization and noise reduction of the camera 600 can be provided.

Here, part of the movable portion 50 being capable of intersecting with the virtual plane V1 can be also referred to as part of the movable portion 50 being capable of existing in the virtual plane V1. For example, part of the movable portion 50 does not have to retract from the cutout 200 by the movement of the movable portion 50. That is, cases where part of the movable portion 50 is capable of intersecting with the virtual plane V1 include Case 1 and Case 2 below. Case 1 is a case where part of the movable portion 50 is always in the state of intersecting with the virtual plane V1. Case 2 is a case where part of the movable portion 50 can be switched between a state of intersecting with the virtual plane V1 and a state of not intersecting with the virtual plane V1 by movement of the movable portion 50. The example of the first embodiment is Case 2. To be noted, in a default state such as a state in which the power of the camera 600 is off, part of the movable portion 50 may intersect or not intersect with the virtual plane V1.

In addition, in the first embodiment, the part 31 of the base plate 71 that is part of the fixed portion 80 is present in the cutout 200, and thus intersects with the plane V1. As a result of this, the camera 600 is miniaturized, and the noise is reduced by the shield member 41.

In addition, in the Z direction orthogonal to the virtual plane V1, the shield member 41 preferably overlaps with the entirety of the movable range of the movable portion 50 in the virtual plane V1.

In the first embodiment, the shield member 41 is disposed to overlap with at least part of the cutout 200 in the Z direction. As viewed in the Z direction, the shield member 41 preferably covers a larger area in the area of the cutout 200. Therefore, the shield member 41 is preferably disposed to overlap with the entirety of the cutout 200 in the Z direction.

In other words, in the Z direction (as viewed in the Z direction), the entirety of the cutout 200 overlaps with the shield member 41. In the first embodiment, in the Z direction, the entirety of the cutout 200 overlaps with part of the shield member 41. Here, although nothing is disposed between the cutout 200 and the shield member 41 in the Z direction in the first embodiment, the configuration is not limited to this. For example, an insulating member or a conductive member different from the shield member 41 may be disposed between the cutout 200 and the shield member 41 in the Z direction.

In the first embodiment, the shield member 41 does not have to be electrically connected to the bottom plate 21, and may be, for example, at a floating potential. In this case, the shield member 41 may be fixed to the bottom plate 21 or the bottom exterior 306 by using a fixing member such as an adhesive or a screw.

By employing a configuration like this in which the bottom plate 21 has the cutout 200, the electronic unit 100 and the bottom plate 21 can be brought closer to each other while suppressing interference between the movable portion 50 of the electronic unit 100 and the bottom plate 21. Therefore, the camera 600 can be miniaturized.

FIG. 8B is an explanatory diagram of the camera 600 according to the first embodiment. FIG. 8B schematically illustrates part of the inner structure of the camera 600 in which illustration of the bottom exterior 306 in the camera 600 is omitted. Further, FIG. 8B schematically illustrates a perspective view of the inner structure of the camera 600 as viewed in the +Z direction from below the camera 600.

In the first embodiment, as illustrated in FIG. 8B, the conductive shield member 41 is disposed to oppose the cutout 200. As a result of this, the cutout 200 is covered by the shield member 41. Therefore, the electromagnetic field noise 91a from the ESD application source 90 is shielded by the shield member 41, and thus propagation of the electromagnetic field noise 91a to the cutout 200 can be suppressed.

In addition, the electromagnetic field noises 91b to 91d illustrated in FIG. 8A generated from the ESD current 92c flowing in an end surface defining the cutout 200 are also shielded by the shield member 41, and thus propagation thereof to the cutout 200 can be suppressed.

As described above, the shield member 41 is disposed in the vicinity of the cutout 200, and thus entrance of the ESD noise via the cutout 200 to the image pickup module 6, the processing module 10, and the flexible printed circuit 7 interconnecting the image pickup module 6 and the processing module 10 can be suppressed. As a result of this, a noise induced in the image signal can be reduced, thus disturbance generated in the captured image can be reduced, and the captured image can be maintained at high quality. In addition, stoppage of the camera 600 caused by an error can be suppressed.

To be noted, although a case where the ESD noise is applied to the screw 14b has been described as an example, the ESD noise can be also applied to members other than the screw 14b. For example, the ESD noise can be also applied to the screws 14a, 16a, 16b, 16c, 16d, 16e, 22a, 22b, and 24, the screw receiving portion 22, or the other members. Also in a case like this, when the ESD current flows in the bottom plate 21, propagation of an electromagnetic field noise to part of the electronic unit 100, that is, part of the movable portion 50 and part of the fixed portion 80 can be suppressed. As a result of this, the noise propagated to the image pickup module 6 and the processing module 10 can be reduced, thus disturbance in the captured image can be reduced, and occurrence of a stoppage caused by an error can be reduced.

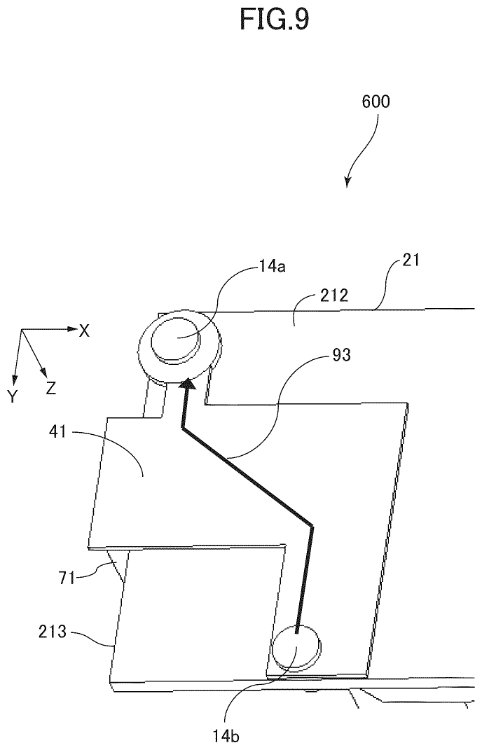

Next, a first modification example of the first embodiment will be described. Although a case where the shield member 41 is not electrically connected to the bottom plate 21 has been described as an example in the first embodiment described above, the configuration is not limited to this. FIG. 9 is an explanatory diagram of the camera 600 according to the first modification example of the first embodiment.

As illustrated in FIG. 9, the shield member 41 may be electrically connected to the bottom plate 21 by being fixed to the bottom plate 21 by using the screws 14a and 14b and the like. That is, the shield member 41 is fixed to the bottom plate 21 by using the screws 14a and 14b arranged with the cutout 200 therebetween, and is thus electrically connected to the bottom plate 21.

The shield member 41 of the first modification example includes a plate-like body, and two fastening portions fixed to the bottom plate 21 by using the screws 14a and 14b. To enhance the reliability of the electrical connection between the bottom plate 21 and the shield member 41, a metal member such as a metal washer is preferably disposed between the bottom plate 21 and the shield member 41 at each of the fastening portion of the shield member 41. To be noted, instead of disposing the washer between the bottom plate 21 and the shield member 41, the fastening portion of the shield member 41 or a portion of the bottom plate 21 comes into contact with the fastening portion may be formed in a protruding shape or a bent shape. As described above, the bottom plate 21 and the shield member 41 are fixed to each other by using fixing members such as the screws 14a and 14b. To be noted, the bottom plate 21 can be a first conductive member including a first conductive part. In addition, the body of the shield member 41 can be a second conductive part. Further, the shield member 41 as a whole can be a second conductive member including a second conductive part.

As a result of the camera of the first modification example being configured as described above, the ESD noise applied to the screw 14b flows in the shield member 41 as the ESD current 93. The ESD current 93 flows from the position of the screw 14b to the position of the screw 14a in an arrow direction in the shield member 41. Further, the ESD current 93 having reached the screw 14a flows to the exterior 300.

According to the first modification example, a bypass route for the ESD current 93 to flow in is formed by the shield member 41, and thus the ESD current 92c along the cutout 200 can be suppressed. Therefore, the electromagnetic field noise entering the electronic unit 100 via the cutout 200 can be reduced. In addition, since the shield member 41 is disposed to cover the cutout 200, the shield member 41 also has a shielding effect against the electromagnetic field noise 91a illustrated in FIG. 8B.

To be noted, the screws 14a and 14b fixing the shield member 41 to the bottom plate 21 are also screws that fix the bottom plate 21 and the bottom exterior 306 to the front exterior 302 and the back exterior 303. Therefore, the shield member 41, the bottom plate 21, and the exterior 300 are collectively fastened and fixed to each other by using the screws 14a and 14b. By employing such a configuration, the ESD current can be supplied from the shield member 41 to the exterior 300, which serves as a more stable ground potential, without passing through other members, and therefore entrance of the ESD noise into the image pickup module 6 and the processing module 10 in the camera 600 can be reduced.

To be noted, as illustrated in FIG. 8B of the first embodiment and FIG. 9 of the first modification example of the first embodiment, the ESD currents and electromagnetic field noises are described by using arrows. This is employed for the sake of convenience of description of the phenomenon, and the direction of the ESD current and the electromagnetic field noise changes in accordance with the difference in the application point of the ESD noise, voltage fluctuation caused by resonance or the like, and the like. Also in such a case, in the first embodiment and the first modification example, since the shield member 41 is disposed in the vicinity of the cutout 200, the electromagnetic field noise reaching the cutout 200 and the electromagnetic field noise derived from the flow of the ESD current can be shielded.

Next, models and simulation results of electromagnetic field simulation performed using a computer for the comparative example, the first embodiment, and the first modification example of the first embodiment will be described.

First, summary of a model used for the electromagnetic field simulation will be described. The bottom plate 21 was configured as a parallelepiped rectangular conductor having a length of 26.3 mm, a width of 81.1 mm, and a thickness of 1.2 mm, and provided with the cutout 200. Here, the length direction was set to the Y direction, the width direction was set to the X direction, and the thickness direction was set to the Z direction. The length direction was also a short-side direction of the bottom plate 21, and the width direction was also a longitudinal direction of the bottom plate 21.

The cutout 200 was set to be obtained by cutting out part of the bottom plate 21 into a rectangular shape having a length of 8.4 mm and a width of 15.9 mm. The cutout 200 was provided at an end of the bottom plate 21 extending in the length direction. The center of the cutout 200 in the length direction was displaced toward the front exterior 302 side by 1.2 mm from the center of the bottom plate 21 in the length direction.

The part 31 of the base plate 71 was positioned in the cutout 200. The width of the part 31 of the base plate 71 in the length direction of the bottom plate 21 was set to 5.9 mm. The height of the part 31 of the base plate 71 in the thickness direction of the bottom plate 21 was set to 0.35 mm, and the length of the part 31 of the base plate 71 in the width direction of the bottom plate 21 was set to 14 mm. The part 31 of the base plate 71 was positioned at a position away by 1 mm from the edge of the cutout 200 closer to the screw 14b.

In the present simulation model, a noise simulating ESD was applied to the screw 14b. In the description below, the positions of the screws 14a and 14b in the comparative example, the first embodiment, and the first modification example will be described. The screw 14a is a screw related to the propagation path of the ESD current, and the screw 14b is a screw serving as an ESD application point.

The screw 14b was disposed at a position that was away by 12.2 mm in the width direction from the end of the bottom plate 21 at which the cutout 200 is provided and that was near an end of the bottom plate 21 on the side closer to the back exterior 303. The screw 14a was disposed at a position near an end of the bottom plate 21 where the cutout 200 was provided such that the cutout 200 was positioned between the screws 14a and 14b.

A rectangular plate material having a length of 10 mm, a width of 19.2 mm, and a thickness of 0.35 mm was used as the shield member 41 of the first embodiment. The material of the shield member 41 of the first embodiment was set to aluminum. The shield member 41 was disposed at a position where the shield member 41 covered the entirety of the cutout 200 as viewed in the Z direction and that was away from the bottom plate 21 by 0.2 mm in the −Z direction.

A plate material including a rectangular body having a length of 10 mm, a width of 19.2 mm, and a thickness of 0.35 mm and two fastening portions which protruded from the rectangular body and via which the shield member 41 was fixed to the bottom plate 21 by using the screws 14a and 14b was used as the shield member 41 of the first modification example. The material of the shield member 41 of the first modification example was set to aluminum.

A metal washer having a thickness of 0.2 mm was disposed between the bottom plate 21 and the shield member 41 at each of the fastening portions of the shield member 41 such that the bottom plate 21 and the shield member 41 were electrically connected to each other.

Next, a signal line observed in the simulation will be described. In the present simulation, a signal line used for transmission of an image signal connected from the image pickup module 6 to the processing module 10 via the flexible printed circuit 7 was used. The signal line was connected to a ground pattern that was a reference voltage pattern of the processing module 10 at a termination resistance set in consideration of a receiver IC of the image signal. In the present simulation, a noise voltage induced in the signal was observed at the termination resistance provided in the processing module 10.

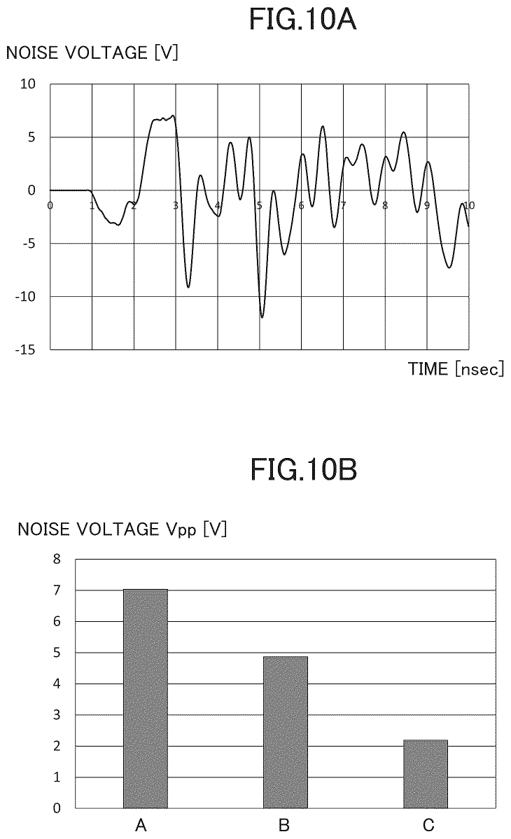

FIGS. 10A and 10B are graphs illustrating results of the simulation. FIG. 10A illustrates a voltage waveform induced in the signal line in a period from 0 to 10 nsec in the comparative example not provided with the shield member 41. It can be seen from FIG. 10A that a voltage fluctuation of a large pulse width is induced in the signal line before 4 nsec.

FIG. 10B illustrates the value of the noise voltage induced in the signal line for each of the comparative example, the first embodiment, and the first modification example of the first embodiment. In FIG. 10B, “A” represents a simulation result of the comparative example not provided with the shield member 41, “B” represents a simulation result of the first embodiment provided with the shield member 41, and “C” represents a simulation result of the first modification example provided with the shield member 41.

To be noted, the noise voltage mentioned herein is a 0-to-peak value of the first waveform of a large pulse width observed before the elapse of 4 nsec after a waveform simulating ESD is applied.

It can be seen from the simulation result illustrated in FIG. 10B that the noise voltage induced in the signal line is reduced by the shield member 41. In addition, it can be seen that the noise voltage is further reduced from the first embodiment in the first modification example.

As described above, according to the configuration of the first embodiment or the first modification example, the ESD noise entering the inside of the camera 600 can be reduced, and the voltage fluctuation induced in the signal line can be reduced. In addition, according to the first modification example, since the shield member 41 is electrically connected to the bottom plate 21, the voltage fluctuation induced in the signal line can be further reduced. Therefore, a technique advantageous for miniaturization and noise reduction of the camera 600 can be provided.

To be noted, although a case where the shield member 41 is a flat plate has been described as an example in the first embodiment and the first modification example, the configuration is not limited to this. For example, the shield member 41 may have a bent portion following the shape of the exterior 300.

In addition, although a case where the shield member 41 is disposed inside the exterior 300 has been described as an example in the first embodiment and the first modification example, the configuration is not limited to this. For example, the shield member 41 may be configured to constitute part of the exterior.

In addition, the shield member 41 is not limited to a plate shape as long as the shield member 41 is conductive. For example, the shield member 41 may be a metal member having a rectangular parallelepiped shape, a conductor having a sheet shape, a gasket formed from conductive cloth, or the like.

### Second Embodiment

A second embodiment of the present disclosure will be described. In the description below, it is assumed that elements denoted by the same reference signs as in the first embodiment have substantially the same configurations and functions as those described in the first embodiment unless otherwise described, and parts different from the first embodiment will be mainly described.

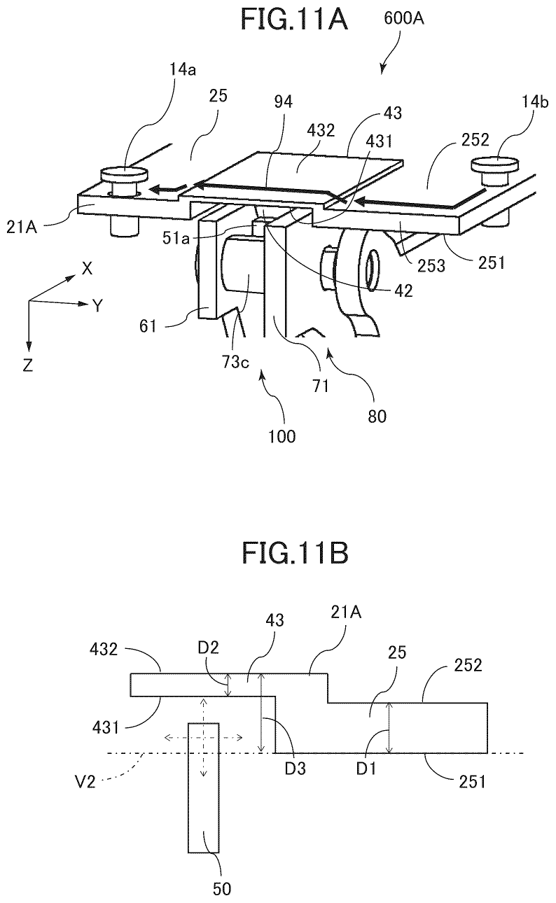

FIGS. 11A and 11B are explanatory diagrams of a camera 600A according to the second embodiment. FIG. 11A schematically illustrates a perspective view of part of the inner structure of the camera 600A in which illustration of the bottom exterior 306 of the camera 600A is omitted. FIG. 11B is an explanatory diagram of a positional relationship between a bottom plate 21A and the movable portion 50.

As illustrated in FIG. 11A, the camera 600A of the second embodiment includes the bottom plate 21A and the electronic unit 100. FIG. 11A illustrates part of the electronic unit 100 and part of the bottom plate 21A. The camera 600A of the second embodiment has a configuration in which the bottom plate 21 of the camera 600 of the first embodiment is replaced by the bottom plate 21A and in which the shield member 41 is omitted. That is, the bottom plate 21A has a function as a shield member.

The bottom plate 21A is a conductive plate. The bottom plate 21A includes a plate body 25, and a conductive part 43 integrated with the plate body 25. In other words, the bottom plate 21A integrally includes the plate body 25 and the conductive part 43. That is, the plate body 25 and the conductive part 43 are each a part of the bottom plate 21A. The bottom plate 21A is an example of a conductive member. The plate body 25 is an example of a first conductive part, and the conductive part 43 is an example of a second conductive part.

A configuration in which a current flows from the plate body 25 to the conductive part 43 is employed. That is, the plate body 25 and the conductive part 43 are electrically connected to each other.

The bottom plate 21A is disposed on the −Z side with respect to the electronic unit 100. As viewed in the Z direction, the bottom plate 21A is a conductive member having an approximate rectangular shape, and is fixed to the bottom exterior 306 of the exterior 300 illustrated in FIG. 1 by using a conductive screw or the like. The bottom plate 21A is disposed between the bottom exterior 306 and the electronic unit 100.

The plate body 25 has a main surface 251 and a main surface 252 on the opposite side to the main surface 251. The main surface 251 is a main surface facing toward the electronic unit 100, that is, a main surface facing inward, and the main surface 252 is a main surface facing toward the bottom exterior 306, that is, a main surface facing outward. The main surface 251 is an example of a first main surface, and the main surface 252 is an example of a second main surface. The main surfaces 251 and 252 are, for example, flat surfaces parallel to the X-Y plane. The main surfaces 251 and 252 are substantially parallel to each other. Therefore, a direction orthogonal to the main surface 251 is substantially the same as a direction orthogonal to the main surface 252.

To be noted, the screw receiving portion 22 illustrated in FIG. 3 is fixed to the bottom plate 21A similarly to the first embodiment. In addition, similarly to the first embodiment, the bottom plate 21A and the bottom exterior 306 of the first embodiment are fixed to the front exterior 302 and the back exterior 303 of FIG. 1 by using a plurality of metal screws. FIG. 11A illustrates the two screws 14a and 14b among the plurality of screws.

Accompanied by miniaturization of the camera 600A, the electronic unit 100 is accommodated in a small space inside the exterior 300 illustrated in FIG. 1. To suppress interference between the movable portion 50 and the bottom plate 21A while securing a movable range of the movable portion 50 of the electronic unit 100, the bottom plate 21A of the second embodiment has a hole 42 that part of the movable portion 50 can enter. That is, the bottom plate 21A of the second embodiment has a hole 42 instead of the cutout 200 described in the first embodiment. The hole 42 is a space defined by the bottom plate 21A. The position of the hole 42 in the bottom plate 21A is approximately the same as the position of the cutout 200 in the bottom plate 21. The part of the movable portion 50 is the protrusion portion 51a of the movable frame 51 similarly to the first embodiment. The movable portion 50 is movable in a space defined by the hole 42 provided in the bottom plate 21A.

The hole 42 is a recess hole recessed in the −Z direction away from the electronic unit 100 with respect to the main surface 251. That is, the hole 42 is a recess portion. The depth of the hole 42 in the Z direction is equal to or larger than the thickness of the plate body 25 in the Z direction. Therefore, the conductive part 43 includes a protrusion portion provided at a position corresponding to the hole 42 and protruding in the −Z direction away from the electronic unit 100 with respect to the main surface 252. That is, the protrusion portion is disposed on the side of the bottom plate 21A opposite to the hole 42 side.

In the second embodiment, the conductive part 43 has a main surface 431 and a main surface 432 on the opposite side to the main surface 431. The main surface 431 is an example of a third main surface, and the main surface 432 is an example of a fourth main surface. The main surface 431 is a surface on the hole 42 side. The main surface 432 is a surface on the protrusion portion side.

In addition, the opening of the hole 42 may be provided on the end surface 253 side of the bottom plate 21A so as to avoid the interference between the bottom plate 21A and the movable frame 51 or the base plate 71. The end surface 253 is, for example, an end surface of the bottom plate 21A on the distal end side in the −X direction.

As illustrated in FIG. 11B, a virtual plane V2 including the main surface 251 and extending along the main surface 251 is defined. The main surface 431 is positioned between the virtual plane V2 and the main surface 432. In addition, the main surface 251 is positioned between the fixed portion 80 and the main surface 252. In addition, the main surface 431 is positioned between the movable portion 50 and the main surface 432. Further, part of the movable portion 50 is capable of moving with respect to the plate body 25 and the conductive part 43 and intersecting with the virtual plane V2. As a result of this configuration, according to the second embodiment, a technique advantageous for miniaturization and noise reduction of the camera 600A can be provided.

Here, part of the movable portion 50 being capable of intersecting with the virtual plane V2 can be also referred to as part of the movable portion 50 being capable of existing in the virtual plane V2. For example, part of the movable portion 50 does not have to retract from the hole 42 by the movement of the movable portion 50. That is, cases where part of the movable portion 50 is capable of intersecting with the virtual plane V2 include Case 1 and Case 2 below. Case 1 is a case where part of the movable portion 50 is always in the state of intersecting with the virtual plane V2. Case 2 is a case where part of the movable portion 50 can be switched between a state of intersecting with the virtual plane V2 and a state of not intersecting with the virtual plane V2 by movement of the movable portion 50. The example of the second embodiment is Case 2. To be noted, in a default state such as a state in which the power of the camera 600A is off, part of the movable portion 50 may intersect or not intersect with the virtual plane V2.

In the second embodiment, a distance D2 between the main surface 431 and the main surface 432 is smaller than a distance D1 between the main surface 251 and the main surface 252. That is, the conductive part 43 is thinner than the plate body 25. In addition, a distance D3 between the main surface 432 and the virtual plane V2 is larger than the distance D1 between the main surface 251 and the main surface 252. That is, the conductive part 43 protrudes in the −Z direction with respect to the plate body 25.

As a result of the configuration described above, the ESD noise applied to the screw 14a flows from the screw 14a to the screw 14b as an ESD current 94 via an edge of the bottom plate 21A, that is, via an edge of the plate body 25 and an edge of the conductive part 43. The ESD current 94 having reached the screw 14a flows to the exterior 300 illustrated in FIG. 1 serving as a more stable ground potential. Therefore, entrance of the ESD noise to the image pickup module 6, the processing module 10, and the flexible printed circuit 7 interconnecting the image pickup module 6 and the processing module 10 can be suppressed. As a result of this, the noise induced in the image signal can be reduced, the disturbance occurring in the captured image can be reduced, and thus the quality of the captured image can be maintained high. In addition, stoppage of the camera 600A caused by an error can be suppressed.

In addition, in the second embodiment, since part of the fixed portion 80 is present in the hole 42, the fixed portion 80 intersects with the virtual plane V2. As a result of this, the camera 600A is miniaturized, and the noise is reduced by the conductive part 43.

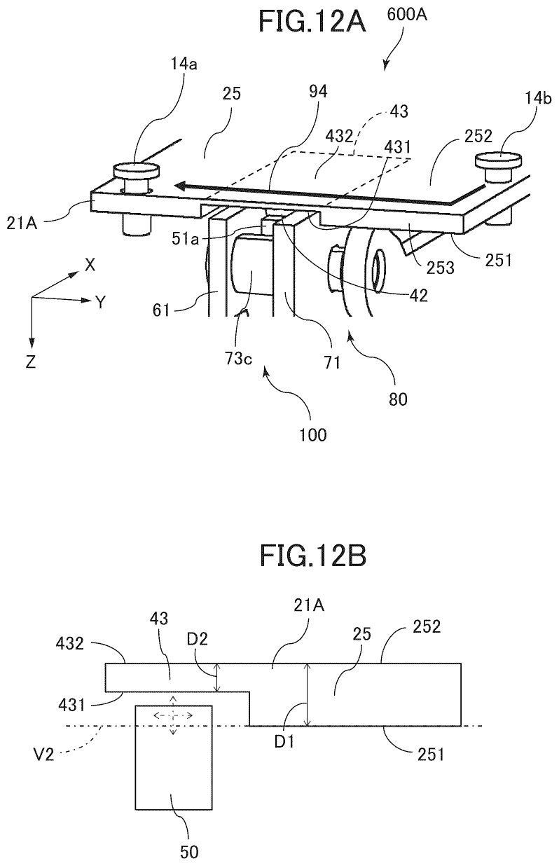

Next, a second modification example of the second embodiment will be described. Although a case where the depth of the hole 42 in the Z direction is equal to or larger than the thickness of the plate body 25 in the Z direction has been described in the second embodiment described above, the configuration is not limited to this. FIGS. 12A and 12B are explanatory diagrams of the camera 600A according to the second modification example of the second embodiment. FIG. 12A schematically illustrates a perspective view of part of the inner structure of the camera 600A in which illustration of the bottom exterior 306 of the camera 600A is omitted. FIG. 12B is an explanatory diagram of a positional relationship between the bottom plate 21A and the movable portion 50.

The depth of the hole 42 in the Z direction may be smaller than the thickness of the plate body 25 in the Z direction. In the case of the configuration of the second modification example, the distance D2 between the main surface 431 and the main surface 432 is smaller than the distance D1 between the main surface 251 and the main surface 252. That is, the thickness of the conductive part 43 in the Z direction is smaller than the thickness of the plate body 25 in the Z direction. Further, in the second modification example, a protrusion portion as in the second embodiment does not need to be provided at a position corresponding to the hole 42. That is, in the bottom plate 21A, no protrusion portion is provided on the side opposite to the hole 42 side, and the main surface 252 and the main surface 432 are flush. By employing such a configuration, the noise reduction effect can be obtained similarly to the second embodiment, and the protrusion of the bottom plate 21A in the thickness direction can be suppressed.

### Third Embodiment

A third embodiment of the present disclosure will be described. In the description below, it is assumed that elements denoted by the same reference signs as in the first embodiment have substantially the same configurations and functions as those described in the first embodiment unless otherwise described, and parts different from the first embodiment will be mainly described.

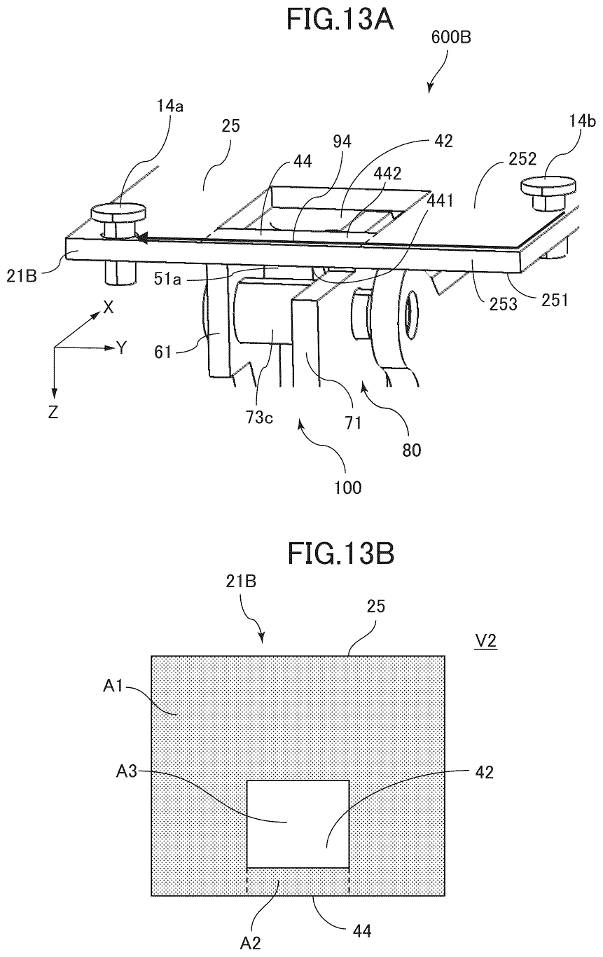

Although a case where the hole 42 is a recess hole has been described in the second embodiment described above, the configuration is not limited to this. FIG. 13A is an explanatory diagram of a camera 600B according to the third embodiment. FIG. 13A schematically illustrates a perspective view of part of the inner structure of the camera 600B in which illustration of the bottom exterior 306 of the camera 600B is omitted.

As illustrated in FIG. 13A, the camera 600B of the third embodiment includes a bottom plate 21B and the electronic unit 100. FIG. 13A illustrates part of the electronic unit 100 and part of the bottom plate 21B. The camera 600B of the third embodiment has a configuration in which the bottom plate 21 of the camera 600 of the first embodiment is replaced by the bottom plate 21B and in which the shield member 41 is omitted. That is, the bottom plate 21B has a function as a shield member.

The bottom plate 21B is a conductive plate. The bottom plate 21B includes a plate body 25, and a conductive part 44 integrated with the plate body 25. In other words, the bottom plate 21B integrally includes the plate body 25 and the conductive part 44. That is, the plate body 25 and the conductive part 44 are each a part of the bottom plate 21B. The bottom plate 21B is an example of a conductive member. The plate body 25 is an example of a first conductive part, and the conductive part 44 is an example of a second conductive part.

The positional relationship and fixation relationship of the bottom plate 21B, the electronic unit 100, and the bottom exterior 306 are substantially the same as the positional relationship and fixation relationship of the bottom plate 21, the electronic unit 100, and the bottom exterior 306 described in the first embodiment, and therefore description thereof will be omitted.

In the third embodiment, the plate body 25 has a main surface 251 and a main surface 252 on the opposite side to the main surface 251 similarly to the first embodiment. The main surface 251 is an example of a first main surface, and the main surface 252 is an example of a second main surface. The conductive part 44 includes a main surface 441 and a main surface 442 on the opposite side to the main surface 441. The main surface 441 is an example of a third main surface, and the main surface 442 is an example of a fourth main surface. The hole 42 is defined by the plate body 25 and the conductive part 44. In the third embodiment, the main surface 251 and the main surface 441 are flush, and the main surface 252 and the main surface 442 are flush.

FIG. 13B is an explanatory diagram of the bottom plate 21B and the virtual plane V2. FIG. 13B illustrates the bottom plate 21B in the virtual plane V2 as viewed in the Z direction orthogonal to the virtual plane V2. Similarly to the second embodiment, the virtual plane V2 including the main surface 251 and extending along the main surface 251 is defined. The virtual plane V2 includes a first region A1 overlapping with the plate body 25 in the Z direction orthogonal to the virtual plane V2, a second region A2 overlapping with the conductive part 44 in the Z direction orthogonal to the virtual plane V2, and a third region A3 between the first region A1 and the second region A2.

A configuration in which a current flows from the plate body 25 to the conductive part 44 is employed. That is, the plate body 25 and the conductive part 44 are electrically connected to each other. In the third embodiment, the plate body 25 and the conductive part 44 are integrally formed. In other words, the bottom plate 21B integrally includes the plate body 25 and the conductive part 44. That is, the plate body 25 and the conductive part 44 are each a part of the bottom plate 21B.

Part of the movable portion 50 is capable of moving with respect to the plate body 25 and the conductive part 44 and intersecting with the third region A3. As a result of the configuration described above, according to the third embodiment, a technique advantageous for miniaturization and noise reduction of the camera 600B can be provided.

As illustrated in FIG. 13A, the hole 42 may be a through hole penetrating the bottom plate 21B in the Z direction. In this case, most of the ESD current 94 flows in edges between the main surfaces 252 and 442 and the end surface 253. Therefore, the ESD current 94 does not flow in a path bypassing the cutout 200 illustrated in FIG. 8A, thus flows in a path away from the hole 42, and the electromagnetic field noise passing through the hole 42 is reduced even in the case where an electromagnetic field noise is generated by the ESD current 94.

In addition, in the comparative example illustrated in FIG. 8A, the ESD current 92c bypasses the cutout 200, thus the electromagnetic field noises 91b, 91c, and 91d pass through the cutout 200, and therefore the intensity of the electromagnetic field noise is high.

In contrast, in the third embodiment, as illustrated in FIG. 13A, the ESD current 94 hardly flows in the edge of the hole 42, and dominantly flows in the edge of the conductive part 44 that is an edge between the main surface 442 and the end surface 253 without bypassing the hole 42. As described above, generation of electromagnetic field noises that intensify each other such as the electromagnetic field noises 91b, 91c, and 91d of FIG. 8A can be suppressed, and thus the electromagnetic field noise passing through the hole 42 can be reduced. Since the electromagnetic field noise passing through the hole 42 is reduced, occurrence of disturbance in the captured image can be effectively reduced.

In addition, since the thickness of the conductive part 44 that the ESD current 94 passes through is equal to that of the plate body 25, the change in the sectional area that the ESD current 94 flows through is small. Since the change in the sectional area is small, the change in the electric resistance is also small. Therefore, the ESD current 94 is likely to flow in the edge of the conductive part 44 included in the edge of the bottom plate 21B, and thus the electromagnetic field noise passing through the hole 42 can be suppressed more effectively.

In addition, in the third embodiment, since part of the fixed portion 80 is present in the hole 42, the fixed portion 80 intersects with the virtual plane V2. As a result of this, the camera 600B is miniaturized, and the noise is reduced by the conductive part 44.

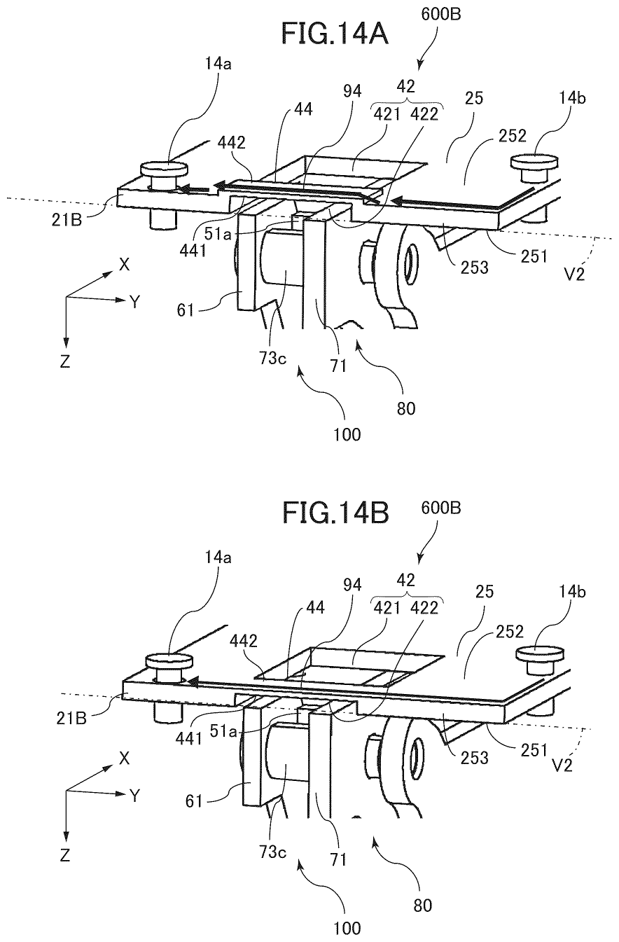

Next, a third modification example of the third embodiment will be described. Although a case where the hole 42 is a recess hole has been described in the second embodiment described above and a case where the hole 42 is a through hole has been described in the third embodiment described above, the configuration is not limited to this. FIG. 14A is an explanatory diagram of the camera 600B according to the third modification example of the third embodiment. FIG. 14A schematically illustrates a perspective view of part of the inner structure of the camera 600B in which illustration of the bottom exterior 306 of the camera 600B is omitted.

As illustrated in FIG. 14A, the bottom plate 21B includes the plate body 25 and the conductive part 44 integrated with the plate body 25. Further, the hole 42 defined by the plate body 25 and the conductive part 44 may include a through hole 421 and a recess hole 422 continuous with the through hole 421 in the X direction. The through hole 421 is a through hole penetrating the bottom plate 21B in the Z direction. The recess hole 422 is a recess hole recessed in the −Z direction away from the electronic unit 100 with respect to the main surface 251. That is, the recess hole 422 is a recess portion.

The recess hole 422 is defined by the conductive part 44. The depth of the recess hole 422 in the Z direction is equal to or larger than the thickness of the plate body 25 in the Z direction. Therefore, the bottom plate 21B includes a protrusion portion provided at a position corresponding to the recess hole 422 and protruding in the −Z direction away from the electronic unit 100 with respect to the main surface 252. That is, the protrusion portion is disposed on the side of the bottom plate 21B opposite to the recess hole 422 side. The conductive part 44 includes the protrusion portion. The thickness of the conductive part 44 in the Z direction is smaller than the thickness of the plate body 25 in the Z direction. That is, the bottom plate 21B includes a thick portion for securing strength, and a thin portion serving as the conductive part 44 corresponding to the recess hole 422.

The distance between the main surface 441 and the main surface 442 is smaller than the distance between the main surface 251 and the main surface 252. That is, the conductive part 44 is thinner than the plate body 25. In addition, the distance between the main surface 442 and the virtual plane V2 is larger than the main surface 251 and the main surface 252. That is, the conductive part 44 protrudes in the −Z direction with respect to the plate body 25.

In addition, the opening of the recess hole 422 may be provided on the end surface 253 side of the bottom plate 21B so as to avoid the interference between the bottom plate 21B and the movable frame 51 or the base plate 71. The end surface 253 is, for example, an end surface of the bottom plate 21B on the distal end side in the −X direction.

Also in the configuration described above, according to the third modification example, the electromagnetic field noise passing through the through hole 421 is reduced, and therefore occurrence of disturbance in the captured image can be effectively reduced.

Next, a fourth modification example of the third embodiment will be described. Although a case where the hole 42 includes the through hole 421 and the recess hole 422 and a protrusion portion is provided on the side opposite to the recess hole 422 has been described in the third modification example described above, the configuration is not limited to this. FIG. 14B is an explanatory diagram of the camera 600B according to the fourth modification example of the third embodiment. FIG. 14B schematically illustrates a perspective view of part of the inner structure of the camera 600B in which illustration of the bottom exterior 306 of the camera 600B is omitted.

The depth of the hole 422 in the Z direction may be smaller than the thickness of the plate body 25 in the Z direction. In the case of the configuration of the fourth modification example, the distance between the main surface 441 and the main surface 442 is smaller than the distance between the main surface 251 and the main surface 252. That is, the thickness of the conductive part 44 in the Z direction is smaller than the thickness of the plate body 25 in the Z direction. Further, in the fourth modification example, as illustrated in FIG. 14B, the side of the bottom plate 21B opposite to the recess hole 422 side does not have to protrude as in the second modification example. That is, in the bottom plate 21B, no protrusion portion is provided on the side opposite to the recess hole 422 side, and the main surface 252 and the main surface 442 are flush.

Also in the configuration described above, according to the fourth modification example, the electromagnetic field noise passing through the through hole 421 is reduced, and therefore occurrence of disturbance in the captured image can be effectively reduced. In addition, protrusion of the bottom plate 21B in the thickness direction can be suppressed.

To be noted, in any of the third embodiment and the third and fourth modification examples of the third embodiment, a shield member may be provided at a position opposing the through hole similarly to the first embodiment and the first comparative example of the first embodiment. As described above, according to the third embodiment and the third and fourth modification examples of the third embodiment, a technique advantageous for miniaturization and noise reduction of the camera 600B can be provided.

### OTHER MODIFICATION EXAMPLES

The present disclosure is not limited to the embodiments described above, and the embodiments can be modified in many ways within the technical concept of the present disclosure. For example, among the plurality of embodiments and plurality of modification examples described above, at least two may be combined. In addition, the effects described in the embodiments are merely enumeration of the most preferable effects that can be obtained from the embodiments of the present disclosure, and the effects of embodiments of the present disclosure are not limited to those described in the embodiments.

Although a case where the bottom plate is a conductive plate having a cutout or a hole has been described in the embodiments described above, the configuration is not limited to this. For example, another conductive plate in the camera may have the cutout or hole described above. In the case where the conductive plate has a cutout, the shield member described above may be disposed in the vicinity of the cutout.

In addition, although a case where the first main surface of the plate body of the bottom plate is parallel to the X-Y plane has been described in the embodiments described above, the configuration is not limited to this, and the first main surface of the plate body may be inclined with respect to the X-Y plane. In this case, the movable portion may be moved in a plane parallel to the X-Z plane intersecting with the first main surface of the plate body.

The electronic device to which the embodiments described above are applicable may be an information device such as a smartphone or a personal computer, or a communication device such as a modem or a router. Alternatively, the electronic device may be an office device such as a printer or a copier, a medical device such as an X-ray imaging apparatus or an endoscope, an industrial device such as a robot or a semiconductor manufacturing apparatus, or a transport device such as a car, an airplane, or a ship. In the electronic device of the present embodiment, the electronic unit and the conductive plate can be disposed in a limited space inside the exterior, which is advantageous for miniaturization of the electronic device and improvement in the performance thereof.

The disclosure of the present specification is not limited to what is explicitly described in the present specification, and includes all the matter that can be grasped from the present specification and the drawings attached to the present specification. In addition, the disclosure of the present specification includes a complementary set of each individual concept described in the present specification. That is, if the present specification includes a description of “A is B”, it can be said that the present disclosure discloses a concept of “A is not B” even if description of the concept of “A is not B” is omitted. This is because there is a premise that in the case where the concept of “A is B” is described, a case where “A is not B” has been already considered.

According to the present disclosure, a technique advantageous for miniaturization and noise reduction of an electronic device can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-018735, filed Feb. 9, 2024, which is hereby incorporated by reference herein in its entirety.

What is claimed is:

1. An electronic device comprising:
an electronic unit including a fixed portion and a movable portion movable with respect to the fixed portion;
a first conductive part having a first main surface and a second main surface provided on a side opposite to the first main surface; and
a second conductive part having a third main surface and a fourth main surface provided on a side opposite to the third main surface,
wherein the first main surface is positioned between the fixed portion and the second main surface,
wherein the third main surface is positioned between the movable portion and the fourth main surface,
wherein the third main surface is positioned between the fourth main surface and a virtual plane including the first main surface and extending along the first main surface, and
wherein part of the movable portion is capable of moving with respect to the first conductive part and the second conductive part and intersecting with the virtual plane.

2. An electronic device comprising:
an electronic unit including a fixed portion and a movable portion movable with respect to the fixed portion;
a first conductive part having a first main surface and a second main surface provided on a side opposite to the first main surface; and
a second conductive part having a third main surface and a fourth main surface provided on a side opposite to the third main surface,
wherein a virtual plane including the first main surface and extending along the first main surface has a first region overlapping with the first conductive part in a direction orthogonal to the virtual plane, a second region overlapping with the second conductive part in the direction orthogonal to the virtual plane, and a third region between the first region and the second region,
wherein a current is configured to flow from the first conductive part to the second conductive part, and
wherein part of the movable portion is capable of moving with respect to the first conductive part and the second conductive part and intersecting with the third region.

3. The electronic device according to claim 1, wherein the part of the movable portion is a conductive portion.

4. The electronic device according to claim 1, wherein part of the fixed portion intersects with the virtual plane.

5. The electronic device according to claim 4, wherein the part of the fixed portion is a conductive portion.

6. The electronic device according to claim 1,
wherein the first conductive part is part of a conductive member, and
wherein the movable portion is movable in a space defined by a cutout or a hole provided in the conductive member.

7. The electronic device according to claim 6, wherein the hole is a through hole or a recess hole recessed with respect to the first main surface, or includes a through hole and a recess hole continuous with the through hole and recessed with respect to the first main surface.

8. The electronic device according to claim 7, wherein the recess hole has an opening on an end surface side of the conductive member.

9. The electronic device according to claim 1,
wherein a distance between the third main surface and the fourth main surface is smaller than a distance between the first main surface and the second main surface,
wherein a distance between the fourth main surface and the virtual plane is larger than the distance between the first main surface and the second main surface, and/or
wherein a distance between the third main surface and the virtual plane is smaller than a distance between the second main surface and the virtual plane.

10. The electronic device according to claim 1, wherein in a direction orthogonal to the virtual plane, the second conductive part overlaps with entirety of a movable range of the movable portion in the virtual plane.

11. The electronic device according to claim 1, wherein the second conductive part is electrically connected to the first conductive part.

12. The electronic device according to claim 1, wherein a first conductive member including the first conducive part and a second conductive member including the second conductive part are fixed to each other by a fixing member.

13. The electronic device according to claim 1, wherein the first conductive part and the second conductive part are integrated in a conductive member.

14. The electronic device according to claim 1, wherein the electronic unit includes an actuator configured to move the movable portion.

15. The electronic device according to claim 1, further comprising:
an exterior member disposed on the second main surface side of the first conductive part,
wherein the exterior member is fixed to a conductive member including the first conductive part by using a metal screw.

16. The electronic device according to claim 15, wherein the exterior member is formed from plastics.

17. The electronic device according to claim 1, wherein the movable portion includes an image sensor.

18. The electronic device according to claim 1, wherein a screw receiving portion configured to receive a screw of a tripod is fixed to a conductive member including the first conductive part.

19. The electronic device according to claim 17, further comprising an image processing device configured to receive input of an image signal from the image sensor via a transmission path.

20. The electronic device according to claim 19, wherein the transmission path includes a flexible wiring member.

21. The electronic device according to claim 2, wherein the movable portion includes an image sensor.
